(19) United States
(12) Patent Application Publication
(10) Pub. No.: US 2012/0023239 A1
(43) Pub. Date: Jan. 26, 2012

(54) Creation Method of Multimedia Service and System Thereof

(76) Inventors: Jianming Fan, Guangdong Province (CN); Ning Cheng, Guangdong Province (CN); Pengcheng Li, Guangdong Province (CN)

(21) Appl. No.: 13/259,362

(22) PCT Filed: Aug. 26, 2009
(86) PCT No.: PCT/CN09/73523

§ 371 Date: Sep. 23, 2011

(30) Foreign Application Priority Data
Apr. 15, 2009 (CN) 200910134937.7

(51) Int. Cl. G06F 15/16

(52) U.S. Cl. 709/227

(57) ABSTRACT

The present invention relates to a method for creating multimedia services comprising: creating a signaling link between the first node and the second node; and the second node negotiating multimedia with the first node via the signaling link to establish a media channel for transmitting stream of the multimedia services and complete creation of the multimedia services at the second node. The present invention also relates to a system for creating multimedia services. Therefore, the present invention allows the signaling link between the first node and the second node to be established and to be used for multimedia negotiation to create the media channel and complete the creation of the multimedia services at the second node so as to implement the unified creation of the multimedia services and simplify the scheduling of the multimedia stream.

### TECHNICAL FIELD

The present invention relates to the field of multimedia network television, and more particularly, to a method and system for creating multimedia services using the real time streaming protocol (RTSP).

### BACKGROUND OF THE RELATED ART

In a network television service system, various multimedia services, such as live broadcast and on-demand broadcast, are required to be provided to users at a plurality of nodes. Therefore, the problem of creating multimedia services with the same properties at a plurality of nodes is concerned. For live broadcast services, synchronous access of code streams is required to be implemented at a plurality of nodes; while for on-demand broadcast services, one multimedia stream is required to be stored in a plurality of nodes.

At present, the live broadcast services may be implemented between different nodes by whole network multicast, i.e., the live broadcast services are created at a central node to send media code streams to a multicast router, and each regional node may implement access of the code streams by joining in the multicast. However, the network for transmission is thus restricted to have to support the multicast protocol.

For different types of networking structures, a multimedia system is required to implement one-to-one unicast output services. For the unicast output services, if each node receives code streams from a live broadcast source, the live broadcast source is required to send multiple code streams, thereby increasing bandwidth of the system. However, if the unicast output services are created at the central node and the code streams are designated to be sent to a certain fixed address of a regional node, then coupling degree between the two nodes is increased, and if the address where the regional node receives the code streams is changed, a unicast output address of the central node is required to be changed manually.

In addition, on-demand multimedia stream are required to be stored in multiple nodes. According to the existing unicast mechanism, each of the multiple nodes of the system must distribute the multimedia stream separately.

### CONTENT OF THE INVENTION

A object of the present invention is to solve problems existing in the prior art, such as multimedia stream destination address being unable to be switched dynamically, network transmission modes being restricted and scheduling of multimedia stream being complicated, and to provide a method and system for creating multimedia services such that scheduling of the multimedia stream is simplified and the multimedia services are created by a multimedia control central server in a unified way.

In order to solve the problems described above, the present invention provides a method for creating multimedia services comprising:

establishing a signaling link between a first node and a second node; and

the second node negotiating multimedia with the first node via the signaling link to establish a media channel for transmitting stream of the multimedia services and complete creation of the multimedia services at the second node.

Before the step of establishing the signaling link between the first node and the second node, the method further comprises:

the first node receiving a first creating message of creating the multimedia services, the first creating message containing a service type and storage attribute of the multimedia services designated for the first node; and

completing creation of the multimedia services at the first node based on the service type and storage attribute.

Establishing the signaling link between the first node and the second node comprises:

the second node receiving a second creating message of creating the multimedia services, the second creating message containing the same service type as the first node designated for the second node, an access mode designated for the second node by which the multimedia services are received, a link establishment address and port; and

the second node establishing the signaling link with the first node based on the access mode and the link establishment address and port.

After the step of completing the creation of the multimedia services at the second node, the method further comprises:

the second node maintaining heartbeat with the first node.

When the service type of the multimedia services designated for the first node is live broadcast type and the storage attribute is Store, completing the creation of the multimedia services at the first node based on the service type and storage attribute comprises:

the first node introducing the stream of the multimedia services from a live broadcast source based on the service type being the live broadcast type and storing the stream in the first node to complete the creation of the multimedia services at the first node.

When the service type of the multimedia services designated for the first node is on-demand broadcast type and the storage attribute is Store, completing the creation of the multimedia services at the first node based on the service type and storage attribute comprises:

the first node downloading the stream of the multimedia services from a content source to a local storage device by a file transfer protocol based on the service type being the on-demand broadcast type and storing the stream in the local storage device.

When the access mode is a real time streaming protocol access mode, and the link establishment address and port is the first signaling IP address and port information of the first node, the second node establishing the signaling link with the first node comprises:

the second node sending a signaling link request of creating the access mode as a real time streaming protocol to the first node based on the first signaling IP address and port information of the first node; and

the second node creating a real time streaming protocol signaling link where the access mode is the real time streaming protocol in response to the first node.

The second node negotiating multimedia with the first node via the signaling link to establish a media channel for transmitting stream of the multimedia services and complete creation of the multimedia services at the second node comprises:

the second mode sending a describe signaling containing a service identifier of the multimedia services to the first node over the real time streaming protocol signaling link;

the first node returning a response message of the describe signaling and notifying the second node of data description of the stream of the multimedia services corresponding to the services identifier;

the second node sending a setup signaling to the first node and notifying the first node of information of an IP address and port where the multimedia services are received, which is determined based on the data description;

the first node notifying the second node of information of an IP address and port where the first node sends the multimedia services in response to the setup signaling to establish the media channel for transmitting the stream of the multimedia services

the second node sending a play signaling to the first node; and

the first node completing the creation of the multimedia services at the second node via the established media channel in response to the play signaling sent by the second node.

According to the method, the step of the first node completing the creation of the multimedia services at the second node via the established media channel in response to the play signaling sent by the second node comprises:

the first node sending the stream of the multimedia services to the second node via the media channel; and

the second node receiving the stream of the multimedia services.

According to the method, when the service type is the on-demand type, after the second node receiving the stream of the multimedia services, the method further comprises:

the second node playing the stream of the multimedia services;

the first node sending a playing ending request to the second node; and

the second node receiving the playing ending request to end the playing of the stream of the multimedia services.

According to the method, after the second node maintains heartbeat with the first node, the method further comprises:

the second node sending a message of creating the multimedia services successfully to a multimedia control central server.

According to the method, after the second node sends the message of creating the multimedia services successfully to the multimedia control central server, the method further comprises:

if anomaly occurs in the signaling link, the second node reestablishing a signaling link with the first node.

The present invention also provides a system for creating multimedia services comprising:

a multimedia control central server, configured to send a first creating message of creating multimedia services, the first creating message containing a service type and storage attribute of the multimedia services designated for a first node; and send a second creating message of creating the multimedia services with the same service type as that designated for the first node, the second creating message containing an access mode designated for the second node by which the multimedia services are received, and a link establishment address and port;

a first node, configured to complete creation of the multimedia services based on the first creating message sent by the multimedia control central server; and

a second node, configured to establish a signaling link to negotiate multimedia with the first node based on the access mode of the multimedia services sent by the multimedia control central server, the link establishment address and port, and establish a media channel for transmitting stream of the multimedia services to complete the creation of the multimedia services at the second node.

Therefore, the present invention allows the signaling link between the first node and the second node to be established and to be used for multimedia negotiation to create the media channel and complete the creation of the multimedia services at the second node so as to implement the unified creation of the multimedia services and simplify the scheduling of the multimedia stream.

### BRIEF DESCRIPTION OF THE DRAWINGS

The technique scheme of the present invention will be further described in details in conjunction with the accompanying drawings and embodiments.

FIG. 1 is a flow chart of a method for creating multimedia services in accordance with the first embodiment of the present invention;

FIG. 2 is a specific signaling flow chart of multimedia negotiation in accordance with the present invention;

FIG. 3 is a flow chart of a method for creating multimedia services in accordance with the second embodiment of the present invention; and

FIG. 4 is a block diagram of a system for creating multimedia services in accordance with the present invention.

### PREFERRED EMBODIMENTS OF THE INVENTION

By providing a method and system for creating multimedia services, the present invention allows, in a multimedia system where on-demand broadcast and live broadcast services is provided for users by a plurality of nodes, a multimedia control central server notifies the first node (also called as central node) and the second node (also called as regional node, and there may be multiple regional nodes in the system for creating the multimedia services) to create the same type of services (e.g., to create the multimedia services of a unified live broadcast type or a unified on-demand broadcast type). In particular, the multimedia services is negotiated via a RTSP signaling link established between the central node and the regional nodes so as to avoid the dependence on a live broadcast source when live broadcast services are created, and when on-demand broadcast services are created, stream of the multimedia services required by the users may be distributed to the regional nodes from the central node by the RTSP.

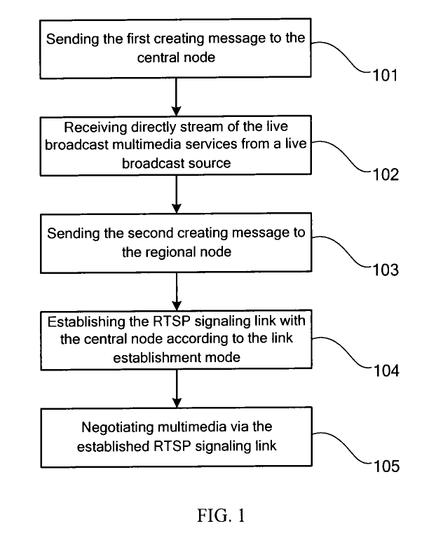

FIG. 1 is a flow chart of a method for creating multimedia services in accordance with the first embodiment of the present invention. The first embodiment of the present invention describes the creation of the multimedia services of the live broadcast type. As shown in FIG. 1, the embodiment comprises the following steps:

Step 101: a multimedia control central server notifies a central node to create the multimedia services, and designates the service type of the created multimedia services to be the live broadcast type and the storage attribute of the multimedia services to be Store, that is, after the multimedia services are created at the central node, stream of the live broadcast multimedia services will be stored in the central node. Of course, alternatively, the storage attribute may be set as No Store. The multimedia control central server may notify the central node by sending the first creating message, which contains the service type and storage attribute of the multimedia services designated for the central node, to the central node.

Step 102: the central node receives directly the stream of the live broadcast multimedia services from a live broadcast source based on the live broadcast type and storage attribute and stores the stream of the multimedia services of the live broadcast type in the central node based on the storage attribute (Store) to complete the creation of the multimedia services.

Step 103: the multimedia service control central server notifies a regional node to create multimedia services. The multimedia service control central server notifies the regional node to create the same type of multimedia services as the central node, i.e., to create the multimedia services of the live broadcast type, and designates an access mode of the multimedia services of the live broadcast type to be the RTSP mode, while designating the first IP address and port where the central node establishes the signaling link (i.e., the IP and port where the central node receives a control signaling) as well as a link establishment mode.

Specifically, the multimedia service control central server notifies the regional node to create the same type of multimedia services as the central node by: sending the second creating message of creating the multimedia services to the regional node, the second creating message containing the designated access mode by which the regional node receives the multimedia services; and designating the link establishment mode between the central node and the regional node, that is, establishing the RTSP signaling link between the central node and the regional node based on the RTSP access mode and the signaling IP address and port information of the regional node.

Step 104: the regional node establishes the RTSP signaling link with the central node based on information contained in the second creating message according to the link establishment mode.

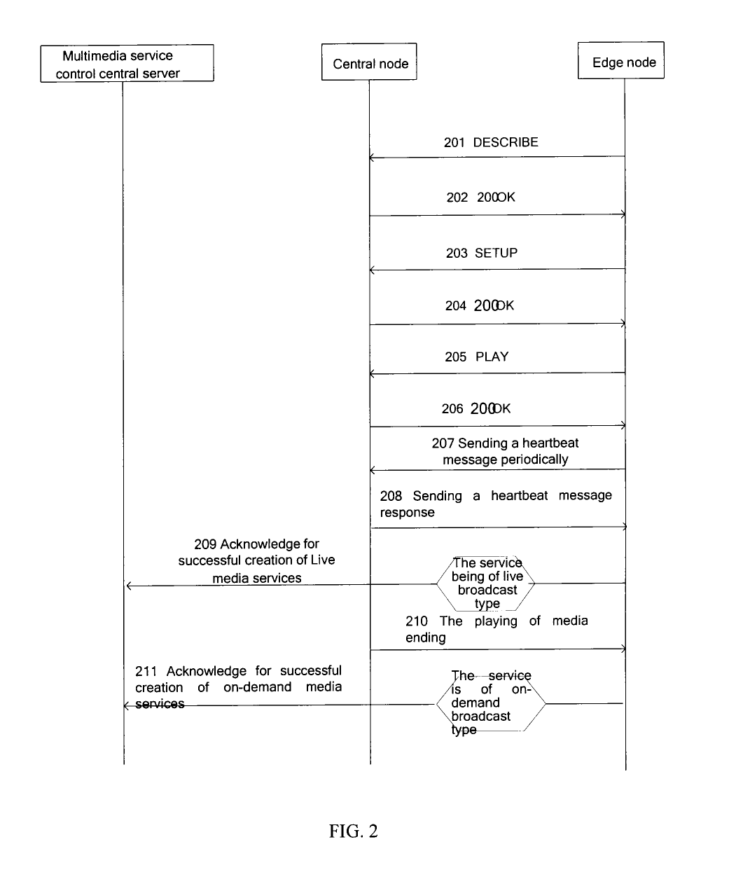

Step 105: the regional node negotiates multimedia with the central node via the established RTSP signaling link to establish a media channel for transmitting the stream of the multimedia services so as to complete the creation of the multimedia services at the second node. Referring to FIG. 2, a specific signaling flow chart of the multimedia negotiation is illustrated.

Step 201: the regional node sends a describe signaling to the central node, and in this signaling, a service identifier is sent to the central node.

Step 202: the central node sends a 200OK response message to indicate the services identified by the service identifier, such as the live broadcast multimedia services identified by the service identifier, which have existed in the central node, and brings, in the response message, description information of the stream of the multimedia services to the regional node in a form of the session description protocol (SDP).

Step 203: after receiving the response message of the describe signaling, the regional node prepares the IP address and port for multimedia service communication based on the SDP description information, and sends a setup signaling to the central node to bring the IP address and port where the multimedia services are received to the central node.

Step 204: after receiving the setup signaling, the central node sends a success acknowledge signaling to the regional node, and notifies, in this signaling, the regional node of the second IP address and port where the central node sends the multimedia services, i.e., establishes the media channel for transmitting the multimedia services to implement the transport of the stream of the multimedia services.

Step 205: the regional node sends a play signaling to the central node.

Step 206: the central node sends a play acknowledge message, which is received by the regional node, to complete the creation of the multimedia services at the second node via the established media channel.

The regional node completes the multimedia negotiation through the specific signaling process of the multimedia negotiation so as to complete the creation of the multimedia services at the regional node, that is, the central node begins the playing of the stream of the multimedia services and transmits, through the negotiated IP address and port where the multimedia is played, the stream of the multimedia services to the negotiated IP address and port where the regional node receives the multimedia. During the creation of the multimedia services at the regional node, the multimedia control central server may also designate the regional node to store service configuration of the live broadcast type in the regional node. Of course, it may be configured as No Store and be configured according actual situations.

Continuing referring to FIG. 1, after step 104, the process further comprises the following step.

Step 106: the regional node maintains heartbeat with the central node. Also referring to step 207 in the signaling diagram illustrated in FIG. 2, a heartbeat message is sent. In step 208, a heartbeat message response is sent.

After completing the creation of the multimedia services of the live broadcast type, the regional node may also send a message of creating the multimedia services successfully to the multimedia control central server when users view the stream of the live-broadcast multimedia services. Furthermore, the central node notifies the regional node that the playing of the multimedia ends. The regional node re-negotiates the multimedia with the central node in the case that the multimedia services is of the live broadcast type currently, i.e., the process shown in FIG. 2 is repeated.

Of course, when one of the central node and the regional node fails in live broadcast services between the two nodes, the IP address and port information used for interacting the stream of the multimedia services between both nodes may be re-negotiated through the RTSP signaling, i.e., the process shown in FIG. 2 is repeated, to re-create the stream of the multimedia services.

The first embodiment of the present invention describes the creation of the multimedia services of the live broadcast type such that in a network television system, each regional node does not need to receive code streams of the multimedia services of the live broadcast type from the same live broadcast source (this feature is embodied during the creation of the multimedia services at the regional node). The dependence of each regional node during the creation of the multimedia services of the live broadcast type is small, because the previous node (i.e., the central node) creates the multimedia services of the live broadcast type, does not need to know detailed parameter information of the next node and is independent of the next node (the regional node); while the next node only need to notify the previous node of the service identifier and the IP address and port information for signaling interacting with the previous node (these features are embodied in the process illustrated in FIG. 2). Moreover, the multimedia service control central server does not need to intervene in the control over the multimedia services of the live broadcast type, thereby simplifying the scheduling of the multimedia stream.

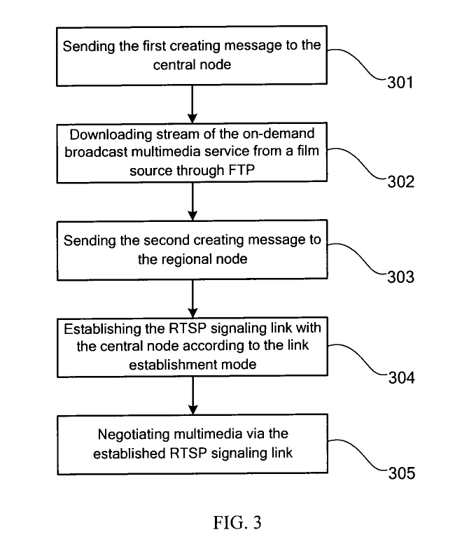

A flow chart of a method for creating multimedia services in accordance with the second embodiment of the present invention is shown in FIG. 3. The second embodiment of the present invention describes the creation of the multimedia services of the on-demand broadcast type. As shown in this figure, the process includes the following steps:

Step 301: a multimedia control central server notifies a central node to create the multimedia services, and designates the service type of the created multimedia services to be the on-demand broadcast type and the storage attribute of the multimedia services to be Store, that is, after the multimedia services are created at the central node, stream of the on-demand broadcast multimedia services will be stored in the central node. The multimedia control central server may notify the central node by sending the first creating message, which contains the service type and storage attribute of the multimedia services designated for the central node, to the central node.

Step 302: the central node downloads the stream of the on-demand broadcast multimedia services from a content source through the file transfer protocol (FTP) based on the on-demand broadcast type and storage attribute and stores the stream of the multimedia services of the on-demand broadcast type in a local storage device of the central node based on the storage attribute (Store) to complete the creation of the multimedia services.

Step 303: the multimedia service control central server notifies a regional node to create multimedia services. The multimedia service control central server notifies the regional node to create the same type of multimedia services as the central node, i.e., to create the multimedia services of the on-demand broadcast type, and designates an access mode of the multimedia services of the on-demand broadcast type to be the RTSP mode, while designating the first IP address and port where the central node establishes the signaling link (i.e., the IP and port where the central node receives a control signaling) as well as a link establishment mode.

Specifically, the multimedia service control central server notifies the regional node to create the same type of multimedia services as the central node by: sending the second creating message of creating the multimedia services to the regional node, the second creating message containing the designated access mode by which the regional node receives the multimedia services, link establishment address and port (the first IP address and port where the central node establishes the signaling link); and designating the link establishment mode between the central node and the regional node, that is, establishing the RTSP signaling link between the central node and the regional node based on the RTSP access mode and the first signaling IP address and port information of the central node.

Step 304: the regional node establishes the RTSP signaling link with the central node based on information contained in the second creating message according to the link establishment mode.

Step 305: the regional node negotiates multimedia with the central node via the established RTSP signaling link to establish a media channel for transmitting the stream of the multimedia services so as to complete the creation of the multimedia services at the second node. Referring to FIG. 2, a specific signaling flow chart of the multimedia negotiation is illustrated.

Step 201: the regional node sends a describe signaling to the central node, and in this signaling, a service identifier is sent to the central node.

Step 202: the central node sends a 2000K response message to indicate the services identified by the service identifier, such as the live broadcast multimedia services identified by the service identifier, which have existed in the central node, and brings, in the response message, description information of the stream of the multimedia services to the regional node in a form of the session description protocol (SDP).

Step 203: after receiving the response message of the describe signaling, the regional node prepares the IP address and port for multimedia service communication based on the SDP description information, and sends a setup signaling to the central node to bring the IP address and port where the multimedia services are received to the central node.

Step 204: after receiving the setup signaling, the central node sends a success acknowledge signaling 200OK to the regional node, and notifies, in this signaling, the regional node of the second IP address and port where the central node sends the multimedia services, i.e., establishes the media channel for transmitting the multimedia services to implement the transport of the stream of the multimedia services.

Step 205: the regional node sends a play signaling to the central node.

Step 206: the central node sends a play acknowledge message 200OK, which is received by the regional node.

The regional node completes the multimedia negotiation through the specific signaling process of the multimedia negotiation so as to complete the creation of the multimedia services at the regional node, that is, the central node begins the playing of the stream of the multimedia services and transmits, through the negotiated IP address and port where the multimedia is played, the stream of the multimedia services to the negotiated IP address and port where the regional node receives the multimedia. During the creation of the multimedia services at the regional node, the multimedia control central server may also designate the regional node to store service configuration of the on-demand broadcast type in the regional node.

Continuing referring to FIG. 1, after step 104, the process further comprises the following step.

Step 306: the regional node maintains heartbeat with the central node. Also referring to step 207 in the signaling diagram illustrated in FIG. 2, a heartbeat message is sent. In step 208, a heartbeat message response is sent.

After the creation of the multimedia services of the on-demand broadcast type is completed and the central node notifies the regional node that the playing of the multimedia ends, and in the case that the multimedia services is of the on-demand broadcast type currently, the regional node notifies the multimedia control central server that the multimedia services of the on-demand broadcast type are created successfully.

The second embodiment of the present invention describes the creation of the multimedia services of the on-demand broadcast type such that in a network television system, for, each regional node only needs to pull down the stream of the multimedia services of the on-demand broadcast type at the central node. The stream of the multimedia services of the on-demand broadcast type required at the regional node is distributed to the regional nodes from the previous node in the RTSP mode, and the multimedia service control central server does not need to intervene in the processing of the multimedia services of the on-demand broadcast type.

From the first embodiment and second embodiment of the present invention described above, it can be seen that the present invention allows the RTSP signaling link between the central node and regional node to be established after introducing the stream of the multimedia services required by the users from a code source or content source or by pulling down the stream of the multimedia services required by the users to the central node in the FTP mode, to implement the multimedia negotiation between the regional node and central node and allow the multimedia stream to be played at the central node over the media channel, i.e., the regional node creates the multimedia services successfully.

For the multimedia services of the live broadcast type, the central node may or may not store the stream thereof, and the regional node may or may not store the stream; while for the multimedia services of the on-demand broadcast type, the central node is required to store the stream thereof locally and the regional node is also required to store the stream locally.

In the present invention, the regional node notifies the multimedia control central server of the result of creating the stream of the multimedia services at different points of time based on different service types. If the multimedia services of the live broadcast type are created, the regional node notifies the multimedia control central server after receiving a play success response and heartbeat message response from the central node; if the on-demand services is created, the regional node notifies the multimedia control central server after the central node notifies the regional node that the playing of the stream of the multimedia services ends, as shown in steps 209-211 in the signaling diagram of FIG. 2. Moreover, the second embodiment has the same advantages as the first embodiment.

In the first embodiment and the second embodiment, in addition to the RTSP mode, the session initiation protocol (SIP) mode may be used as the access node of the multimedia services; and in addition to the RTSP signaling link, the SIP signaling link may be established. Therefore, the effect obtained by the RTSP signaling link is also achieved by establishing the SIP signaling link. The specific implement method is the same as those described in the first embodiment and the second embodiment.

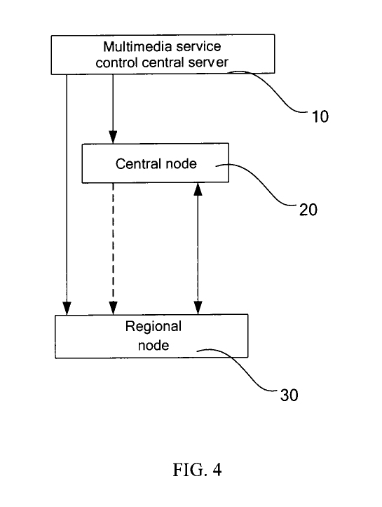

Accordingly, the present invention further provides a system for creating multimedia services. As shown in FIG. 4, the system for creating the multimedia services is configured to comprise 2 nodes, a central node and a regional node, and a media control central server 10 interacts with the central node 20 and the regional node 30 through a control message. The central node negotiates with the regional node via the RTSP signaling parameters required for transmitting media, such as the IP address and port where the regional node receives the multimedia stream channel, the IP address and port where the central node sends the multimedia stream, and service identifier information, while the stream of the multimedia services are transmitted over an independent media channel. Continuing referring to FIG. 4, the system will be described in detail below, which comprises:

the media control central server 10, configured to send the first creating message of creating the multimedia services, the first creating message containing the service type and storage attribute of the multimedia services designated for the first node, and create the second creating message of the multimedia services with the same service type as that designated for the first node, the second creating message containing an access mode designated for the second node by which the multimedia services is received, a link establishment address and port, and a link establishment mode designated between the second node and the first node.

The central node 20, configured to complete the creation of the multimedia services based on the first creating message sent by the media control central server.

The regional node 30, configured to establish a signaling link (as shown by the solid line in the figure) to negotiate multimedia based on the access mode of the multimedia services, the link establishment address and port and the link establishment mode sent by the media control central server so as to establish a media channel for transmitting the stream of the multimedia services upon the successful multimedia negotiation to complete the creation of the multimedia services at the second node, for example, the stream of the multimedia services are played on the media channel shown by the dashed line in the figure.

When the system for creating the multimedia services creates the multimedia services, the central node introduces the stream of the multimedia services from a live broadcast source based on the service type being the live broadcast type to complete the creation of the multimedia services. The central node downloads the stream of the multimedia services from a content source to a local storage device through the FTP based on the service type being the on-demand broadcast type and stores the stream. The regional node sends a signaling link request of creating the access mode as the real time streaming protocol to the regional node based on the signaling IP address and port information of the central node. The regional node responds to the central node to create a real time streaming protocol signaling link in which the access mode is the real time streaming protocol.

The central node negotiates the multimedia via the link which is established based on the link establishment mode such that upon the successful multimedia negotiation, the completing of the creation of the multimedia services at the regional node comprises the following steps:

the regional node sends a describe signaling containing a service identifier of the multimedia services to the central node over the real time streaming protocol signaling link;

the central node returns a response message of the describe signaling and notifies the regional node of data description of the stream of the multimedia services corresponding to the service identifier;

the regional node sends a setup signaling to the central node and notifies the central node of information of the IP address and port where the multimedia services are received, which is determined based on the data description;

the central node notifies the regional node of the information of the IP address and port where the central node sends the multimedia services in response to the setup signaling to establish a media channel for transmitting the stream of the multimedia services;

the regional node sends a play signaling to the central node; and

the central node completes the creation of the multimedia services at the regional node via the established media channel in response to the play signaling sent by the regional node.

After the regional node maintaining the heartbeat with the central node, the process further comprises the following steps:

when the service type is the live broadcast type, the regional node sends a message of creating the multimedia services successfully to the multimedia control central server.

The regional node notifies the multimedia control central server of the result of creating the stream of the multimedia services at different points of time based on different service types. If the service type is the on-demand broadcast type and the central node completes the playing of the stream of the multimedia services in response to the play signaling, the central node sends the message of creating the multimedia services successfully to the media control central. When the service type is the live broadcast type and the central node completes the playing of the stream of the multimedia services in response to the playing signaling, the central node re-negotiates the multimedia with the regional node.

In a system where a plurality of nodes provide the on-demand broadcast and live broadcast services for users, the present invention allows the media control central server to notify the central node to create unified services and designate different storage attributes for different types of services. If the service type is the live broadcast type, the storage attribute may be configured as Store or No Store; for the services of the on-demand type, the storage attribute is configured as Store. Upon the successful creation of the services at the central node, the same type of services are created at the regional node, the access mode of the services is designated as the RTSP mode and the IP address and port where the central node establishes the signaling link is designated. The regional node establishes the RTSP signaling link with the central node. The regional node negotiates media with the central node by the RTSP signaling and the services are created successfully at the regional node upon the successful negotiation. After the services are created successfully at the regional node, the regional node maintains the heartbeat with the central node at the same time. If the service type at the regional node is the live broadcast type, then the media control central server is notified of the successful creation; if the playing of the media ends at the central node, then the regional node is notified of the ending. If the regional node creates the on-demand services, it notifies the media control central server of the successful creation after receiving a message that the playing of the media ends. If the services are the live broadcast services, the regional node re-negotiates the media with the central node to re-create the services.

By using the method and system in accordance with the present invention, a signaling link, which is a private channel of a control signaling and on which the creation of the multimedia services is completed by the multimedia negotiation, is established. That is, a media channel for transmitting the stream of the multimedia services is established by interaction of the control signaling on the signaling link, i.e., the regional node notifies the central node of the IP address and port of the multimedia service communication by the control signaling (setup signaling). The central node notifies the regional node of the IP address and port where the central node sends the multimedia services by the control signaling (200OK) so as to establish the media channel to implement the transport of the stream of the multimedia services to complete the creation of the multimedia services at the regional node.

Management for the live broadcast services and the on-demand services may be unified by using the method and system in accordance with the present invention. For the live broadcast service, its creation at each node does not need to receive code streams of the live broadcast services from a live broadcast source; the dependence of each node during the creation of the live broadcast services is small: the previous node creating the live broadcast services does not need to know detailed information of the output node and is independent of the next node; the next node only needs to designate a service identifier as well as the IP address and port information for signaling interaction with the previous node; and as long as one of the central node and the regional node fails in the live broadcast services between the two nodes, the IP address and port information for media interaction therebetween is renegotiated through the RTSP signaling to re-establish the services. For the on-demand services, the stream thereof is only required to be pulled down by the FTP at the central node, the stream of the services at the regional node are distributed to the local node from the previous node, and the multimedia control central server does not need to intervene in different processing of the multimedia services.

Finally, it should be noted that the embodiments described above are merely intended to illustrate and not to limit the technical scheme of the present invention. Although the present invention is described in details with reference to the preferred embodiments, it should be understood by those having ordinary skills in the art that modifications or equivalent substitutions may be made to the present invention without departing from the spirit and scope of the technical scheme of the present invention and the appended claims.

### INDUSTRIAL APPLICABILITY

The method for creating multimedia services provided by the present invention allows the signaling link between the first node and the second node to be established and to be used for multimedia negotiation to create the media channel and complete the creation of the multimedia services at the second node so as to implement the unified creation of the multimedia services and simplify the scheduling of the multimedia stream.

1. A method for creating multimedia services comprising:
establishing a signaling link between a first node and a second node; and
the second node negotiating multimedia with the first node via the signaling link to establish a media channel for transmitting stream of the multimedia services and complete creation of the multimedia services at the second node.

2. The method according to claim 1, before the step of establishing the signaling link between the first node and the second node, the method further comprising:
the first node receiving a first creating message of creating the multimedia services, the first creating message containing a service type and storage attribute of the multimedia services designated for the first node; and
completing creation of the multimedia services at the first node based on the service type and storage attribute.

3. The method according to claim 1, wherein the step of establishing the signaling link between the first node and the second node comprises:
the second node receiving a second creating message of creating the multimedia services, the second creating message containing the same service type as the first node designated for the second node, an access mode designated for the second node by which the multimedia services are received, a link establishment address and port; and
the second node establishing the signaling link with the first node based on the access mode and the link establishment address and port.

4. The method according to claim 3, after the step of completing the creation of the multimedia services at the second node, the method further comprising:
the second node maintaining heartbeat with the first node.

5. The method according to claim 2, wherein when the service type of the multimedia services designated for the first node is live broadcast type and the storage attribute is Store, completing the creation of the multimedia services at the first node based on the service type and storage attribute comprises:
the first node introducing the stream of the multimedia services from a live broadcast source based on the service type being the live broadcast type and storing the stream in the first node to complete the creation of the multimedia services at the first node.

6. The method according to claim 2, wherein when the service type of the multimedia services designated for the first node is on-demand broadcast type and the storage attribute is Store, completing the creation of the multimedia services at the first node based on the service type and storage attribute comprises:
the first node downloading the stream of the multimedia services from a content source to a local storage device by a file transfer protocol based on the service type being the on-demand broadcast type and storing the stream in the local storage device.

7. The method according to claim 4, wherein when the access mode is a real time streaming protocol access mode, and the link establishment address and port is the first signaling IP address and port information of the first node, the step of the second node establishing the signaling link with the first node comprises:
the second node sending a signaling link request of creating the access mode as a real time streaming protocol to the first node based on the first signaling IP address and port information of the first node; and
the first node creating a real time streaming protocol signaling link where the access mode is the real time streaming protocol in response to the second node.

8. The method according to claim 7, wherein the step of the second node negotiating multimedia with the first node via the signaling link to establish a media channel for transmitting stream of the multimedia services and complete creation of the multimedia services at the second node comprises:
the second mode sending a describe signaling containing a service identifier of the multimedia services to the first node over the real time streaming protocol signaling link;
the first node returning a response message of the describe signaling and notifying the second node of data description of the stream of the multimedia services corresponding to the services identifier;
the second node sending a setup signaling to the first node and notifying the first node of information of an IP address and port where the multimedia services are received, which is determined based on the data description;
the first node notifying the second node of information of an IP address and port where the first node sends the multimedia services in response to the setup signaling to establish the media channel for transmitting the stream of the multimedia services
the second node sending a play signaling to the first node; and
the first node completing the creation of the multimedia services at the second node via the established media channel in response to the play signaling sent by the second node.

9. The method according to claim 8, wherein the step of the first node completing the creation of the multimedia services at the second node via the established media channel in response to the play signaling sent by the second node comprises:
the first node sending the stream of the multimedia services to the second node via the media channel; and
the second node receiving the stream of the multimedia services.

10. The method according to claim 9, when the service type is the on-demand type, after the second node receiving the stream of the multimedia services, the method further comprising:
the second node playing the stream of the multimedia services;
the first node sending a playing ending request to the second node; and
the second node receiving the playing ending request to end the playing of the stream of the multimedia services.

11. The method according to claim 10, after the step of the second node maintaining heartbeat with the first node, the method further comprising:
the second node sending a message of creating the multimedia services successfully to a multimedia control central server.

12. The method according to claim 11, after the step of the second node sending the message of creating the multimedia services successfully to the multimedia control central server, the method further comprising:
if anomaly occurs in the signaling link, the second node reestablishing a signaling link with the first node.

13. A system for creating multimedia services comprising:
a multimedia control central server, configured to send a first creating message of creating multimedia services, the first creating message containing a service type and storage attribute of the multimedia services designated for a first node; and send a second creating message of creating the multimedia services with the same service type as that designated for the first node, the second creating message containing an access mode designated for the second node by which the multimedia services are received, and a link establishment address and port;
a first node, configured to complete creation of the multimedia services based on the first creating message sent by the multimedia control central server; and
a second node, configured to establish a signaling link to negotiate multimedia with the first node based on the access mode of the multimedia services sent by the multimedia control central server, the link establishment address and port, and establish a media channel for transmitting stream of the multimedia services to complete the creation of the multimedia services at the second node.

14. The method according to claim 2, wherein the step of establishing the signaling link between the first node and the second node comprises:
the second node receiving a second creating message of creating the multimedia services, the second creating message containing the same service type as the first node designated for the second node, an access mode designated for the second node by which the multimedia services are received, a link establishment address and port; and
the second node establishing the signaling link with the first node based on the access mode and the link establishment address and port.
